(19) United States
(12) Patent Application Publication
(10) Pub. No.: US 2007/0178199 A1
(43) Pub. Date: Aug. 2, 2007

(54) Granulate containing a functional food ingredient and method for the manufacture thereof

(76) Inventors: Marcel Minor, Wageningen (NL); Eva-Maria Dusterhoft, Wageningen (NL); Stolz Peter, Koenigswinter (DE)

Correspondence Address: Abelman Frayne and Schwab, 666 Third Avenue, New York, NY, 10017-5621, US

(21) Appl. No.: 10/591,308

(22) PCT Filed: Mar. 4, 2005
(86) PCT No.: PCT/NL05/00161

§ 371 Date: Sep. 1, 2006

(30) Foreign Application Priority Data
Mar. 4, 2004 (EP) 04075742.9

(51) Int. Cl. A23L 1/00

(52) U.S. Cl. 426/273; 426/549

(57) ABSTRACT

The present invention relates to a composition comprising at least 0.1 wt. % of granules suitable for use in foodstuffs, said granules having an average diameter in the range of 30-3000 μm and comprising: a. 3-70 wt. of a plurality of non-lipophilic particles with an average diameter in the range of 3-300 μm, said particles containing at least 0.1 wt. % of one or more functional food ingredients; b. 10-80 wt. % of a discrete continuous phase containing at least 90 wt. % lipids, which continuous phase envelops the non-lipophilic particles and holds them together, the combination of non-lipophilic particles and the continuous phase forming an agglomerate with a diameter in the range of 20-2000 μm; and c. 10-80 wt. % of an exterior lipophilic layer that encompasses the agglomerate, which lipophilic layer exhibits a slip melting point of at least 30° C.

### TECHNICAL FIELD OF THE INVENTION

The present invention relates to granulates for use in foodstuffs, which granulates comprise granules containing one or more particulate functional food ingredients. More particularly, the present invention is concerned with granules that comprise an agglomerate containing a plurality of non-lipophilic particles containing one or more functional food ingredients and a discrete continuous phase enveloping said non-lipophilic particles; and an exterior lipophilic layer that encompasses the aforementioned non-lipophilic particles, which lipophilic layer exhibits a slip melting point of at least 30° C.

The present invention also provides a method for the manufacture of the aforementioned granulates.

### BACKGROUND OF THE INVENTION

Functional bakery ingredients are widely used in the baking industry to improve handling and machinability of doughs and also to improve texture, volume, flavour, and freshness (anti-staling) of the final baked product. Examples of functional bakery ingredients that can be used to “condition” a dough include enzymes, oxidoreductants, acidulants, hydrocolloids, micro-organisms and flavours.

An important area of application of functional bakery ingredients is bread. Bread is made from four principal ingredients: flour, yeast, salt and water. It is usually prepared in three basic steps, and the end result is a baked loaf. The steps are: (a) the principal ingredients are mixed to form a dough and worked to develop a continuous visco-elastic gluten matrix; (b) the developed dough is then proved by incubation in warm, humid conditions to promote fermentation by the yeast causing the dough to rise; (c) the risen dough is then baked to gelatinise starch, denature protein and fix the dough structure. Various additives, including the aforementioned functional bakery ingredients, are known to improve dough development and the quality of the baked loaf. These additives are generally known as bread (or flour or dough) improvers/conditioners.

The strength of a dough is an important aspect of baking for both small-scale and large-scale applications. A strong dough has a greater tolerance of mixing time, proving time, and mechanical vibrations during dough transport, whereas a weak dough is less tolerant to these treatments. A strong dough with superior rheological and handling properties results from flour containing a strong gluten network. Flour with a low protein content or a poor gluten quality results in a weak dough.

Non-specific oxidants, such as iodates, peroxides, ascorbic acid, potassium bromate, glutathione and azodicarbonamide have a gluten strengthening effect. It has been suggested that these dough improvers induce the formation of interprotein bonds which strengthen the gluten and thereby the dough. The use of several of the currently available chemical oxidising agents has been met with consumer resistance or is not permitted by regulatory agencies.

The use of enzymes as dough improvers has been considered as an alternative to the chemical conditioners. A number of enzymes have been used recently as dough and/or bread improving agents, in particular enzymes that act on components present in large amounts in the dough. Examples of such enzymes are found within the groups of amylases, xylanases, proteases, glucose oxidases, oxygenases, oxidoreductases, trans-glutaminases and (hemi) cellulases, including pentosanases.

The use of the aforementioned dough improvers is not uncomplicated, since these functional ingredients tend to affect dough properties such as stickiness, strength and/or stability. As a result, the dough can become difficult to handle both by hand and by machines. It would thus be desirable to be able to delay the moment when the conditioner exerts its full functionality until after a selected point in time. In particular, it would be desirable to delay such a moment until all dough ingredients have been mixed and especially until such time that proving of said dough has commenced.

The general principle of lipid-encapsulating or lipid-coating of food ingredients to prevent functional ingredients from exerting their functionality prematurely is known in the art. WO 02/19828 describes dough compositions comprising:
(i) an effective amount of one or more enzyme(s) encapsulated or coated by a lipid substance, wherein said lipid substance (a) provides, at a temperature of less than 25° C., a barrier, which inhibits release of said enzyme(s) to the surrounding dough, and (b) undergoes a phase transition in the temperature range from 25° C. to 60° C.a allowing release of said enzyme(s), and (ii)
(ii) flour and optionally any additional, conventional dough ingredients.
   The encapsulates described in the international patent application preferably comprise at least 95% by weight of capsules with a particle size in the range of 10-200 μm. It is mentioned that the encapsulates may be provided in the form of lipid coated enzyme-containing cores. It is observed that the such cores may be provided in the form of prilled products, wherein an enzyme powder is suspended in molten wax and the suspension is sprayed into a cooling chamber where the droplets quickly solidify. The application refers to the option of applying onto the aforementioned cores a coating comprising e.g. high melting fats such as glycerol esters; phosphoglycerides; waxes; fatty acid alcohols; mono- and/or diglycerides, fatty acids; paraffins and/or microcrystalline wax.

WO 96/16151 describes coated enzyme granulates obtained by (i) contacting enzyme granules with a coating material comprising either (a) a non-aqueous liquid or aqueous emulsion thereof or (b) an unctuous mixture comprising a liquid as in (a) having dissolved therein a second component having a melting point in the range of 30-90° C., so as to provide a substantially uniform coating on said granules of said coating material at less than 25 wt. %, and (ii) contacting the granules formed in step (i) with an anti-caking agent. It is observed that the enzyme granules may be any type known in the art, e.g. prills, having a size of approximately 150-3000 μm, more specifically of 300-2000 μm. The unctuous coating materials are said to comprise at least one solid in addition to the non-aqueous liquid. This solid should have a melting point in the range of 30-90° C. and should dissolve in the liquid upon melting. Suitable solids are said to include PEG, stearic acid, glycerolmonostearate, paraffin, sodium laurate or wax.

Fat coating of particulate functional ingredients is associated with drawbacks that are especially pronounced if said functional ingredients are non-lipophilic or if they have been pre-blended with substantial quantities of non-lipophilic components, e.g. non-lipophilic carrier materials. First of all, it is extremely difficult to prepare such coated particles with a non-leaking coating, especially if the non-lipophilic material is irregularly shaped. In particular when these coated particles are used in applications that involve exposure to conditions of shear, leakage of the coated material is often inevitable. This problem may be overcome by using an excessive amount of fat. However, this is not economical and may adversely affect the release characteristics of the coated material.

Coated materials obtained with conventional fat coating techniques typically exhibit relatively wide particle size distributions and/or significant leakage. Particulate materials with a wide particle size distribution are susceptible to demixing during transportation and storage. Furthermore, the presence of a significant fraction of small particles, e.g. of particles smaller than 250 μm, will result in so called dusting during handling. The term dusting refers to the phenomenon that particles become airborne, which in turn can give rise to health problems, such as allergenicity, when these airborne particles are inhaled.

Finally, conventional fat coating techniques are not suitable for coating blends of two or more particulate ingredients, especially not if these ingredients exhibit different bulk densities or particle sizes. Fat coating of such blends of ingredients with the help of conventional techniques will typically result in an inhomogeneous non-uniform product.

### SUMMARY OF THE INVENTION

The inventors have discovered that the aforementioned problems may be overcome effectively by first preparing an agglomerate of the non-lipophyilic particles containing the one or more functional food ingredients, followed by coating the resulting agglomerate with an exterior lipophilic layer that exhibits a slip melting point of at least 30° C. To be more precise, the inventors have discovered that such a procedure produces particularly beneficial results if a plurality of non-lipophilic particles with an average diameter in the range of 3-300 μm is combined into an agglomerate with an average diameter in the range of 20-2000 μm before applying the exterior lipophilic layer.

In accordance with the present invention the plurality of non-lipophilic particles are agglomerated by “gluing” them together. This is suitably achieved by combining said particles with e.g. a fluid medium and processing the resulting combination under conditions that promote the formation of aggregates in which a continuous phase of said fluid medium envelops a plurality of non-lipophilic particles and holds them together. As a result, the resulting agglomerates can be coated much more easily and effectively with the lipophilic coating material than if such a coating is applied directly onto the original non-lipophilic particles.

The methodology of the present invention offers the advantage that it enables the preparation of fat coated non-lipophilic particles that do not exhibit leakage without resorting to the use of excessive amounts of fat, in other words: the present invention provides non-leaking granulates with a high payload. Moreover, the granules according to the invention show this resistance to leakage even when exposed to conditions of (limited) shear. It should be understood that the term “leakage” as used herein refers to the migration of the coated non-lipophilic material into the surrounding environment, e.g. as a result of the migration of water into the coated granule.

The granules according to the present invention can advantageously be used for delivering the functional ingredients therein in a controlled fashion. The release of such ingredients can suitably be triggered by temperature increase, resulting in melting of the exterior lipophilic layer and/or by conditions of shear that destroy the integrity of the exterior layer. The fact that the present invention enables the preparation of coated granulates that show little leakage and a homogeneous particle size distribution offers the advantage that the release characteristics of the granulate can be tailored to the targeted application.

Furthermore, the invention facilitates the preparation of a uniform and homogeneous granulate in which the fat coated granules contain two or more very different particulate materials, e.g. enzymes and oxidoreductants. Finally, the invention provides an effective method for applying a fat coating to non-lipophilic particles that are irregularly shaped.

The granulates according to the present invention contain at least 0.1 wt. % of granules having an average diameter in the range of 30-3000 μm, said granules being characterised in that they comprise 3-70 wt. % a plurality of non-lipophilic particles with an average diameter in the range of 3-300 μm, said particles containing at least 0.1 wt. % of one or more functional food ingredients; 10-80 wt. % of a discrete continuous phase containing at least 90 wt. % lipids, which continuous phase envelops the non-lipophilic particles and holds them together, the combination of non-lipophilic particles and the continuous phase forming an agglomerate with an average diameter in the range of 20-2000 μm; and 10-80 wt. % of an exterior lipophilic layer that encompasses the agglomerate, which lipophilic layer exhibits a slip melting point of at least 30° C.

### DETAILED DESCRIPTION OF THE INVENTION

Accordingly, one aspect of the invention relates to a composition comprising at least 0.1 wt. % of granules suitable for use in foodstuffs, said granules having an average diameter in the range of 30-3000 μm and comprising:

a. 3-70 wt. % of a plurality of non-lipophilic particles with an average diameter in the range of 3-300 μm, said particles containing at least 0.1 wt. % of one or more functional food ingredients;

b. 10-80 wt. % f a discrete continuous phase containing at least 90 wt. % lipids, which continuous phase envelops the non-lipophilic particles and holds them together, the combination of non-lipophilic particles and the continuous phase forming an agglomerate with a diameter in the range of 20-2000 μm; and

c. 10-80 wt. % of an exterior lipophilic layer that encompasses the agglomerate, which lipophilic layer exhibits a slip melting point of at least 30° C. According to a preferred embodiment, the present composition contains at least 1 wt. %, more preferably at least 10 wt. % of the granules as defined above.

The term “lipophilic” as used in here refers to materials that are oil soluble and that have a maximum solubility in triglyceride oil (e.g. sunflower oil) of 20° C. that is at least 10 times higher than the solubility in water of the same temperature.

The term “non-lipophilic” as used in here refers to materials that are not lipophilic and whose maximum solubility in triglyceride oil of 20° C. does not exceed 0.5 wt. %, preferably does not exceed 0.1 wt. %.

The terminology “lipophilic layer” also encompasses a layer that in addition to lipophilic material contains a certain amount of non-lipophilic material. Preferably, the amount of non-lipophilic material does not exceed 20 wt. %, more preferably it does not exceed 5 wt. %, most preferably the layer contains essentially no non-lipophilic material.

In a particularly preferred embodiment the non-lipophilic particles employed in accordance with the present invention are hydrophilic particles. Here the term “hydrophilic” refers to materials that are water soluble or water dispersible and that dissolve or disperse at least 10 times more (in terms of the maximum amount that can be dissolved or dispersed) in water than in triglyceride oil (e.g. sunflower oil) at a temperature of 20° C.

The terminology “hydrophilic particle” is used to describe particles that largely consist of hydrophilic materials. It is to be understood, however, that in accordance with the present invention the hydrophilic particles may contain some material that is not strictly speaking hydrophilic, e.g. micro-organisms. Preferably the amount of such non-hydrophilic material contained within the hydrophilic particles does not exceed 40 wt. %, more preferably it does not exceed 20 wt. and most preferably it does not exceed 5 wt. %. Most preferably, the hydrophilic materials contained in the hydrophilic particles dissolve at least 10 times more in water of 20° C. than in triglyceride oil of the same temperature.

The diameter or size of particles or granules as referred to in this document is suitably determined by means of sieves in a manner well known to the skilled person. A number of sieves with decreasing pore sizes may be used to establish the particle size distribution of particles and granules in terms of wt. % or vol. %. Whenever reference is made to the average diameter/size or mean diameter/size of particles or granules this refers to the mass weighted average diameter, unless indicated otherwise.

The terminology “discrete continuous phase” refers to a phase that is present within the agglomerate as a distinguishable essentially homogeneous phase that forms a clearly identifiable interface with the non-lipophilic particles contained within the same agglomerate. In order to demonstrate the existence of such an interface it may be useful to employ staining and/or analytical techniques that are capable of detecting such interfaces.

The “slip melting point” is defined herein as the temperature at which the amount of solid phase in the melting fat has become so low that an air bubble is forced upwards in an open capillary filled with the fat.

The benefits of the present invention are particularly pronounced if the non-lipophilic particles in the granules have a relatively small average diameter, e.g. in the range of 10-150 μm, most preferably in the range of 20-100 μm.

The agglomerate as defined herein before contains a plurality of non-lipophilic particles. Consequently, the diameter of the agglomerate typically exceeds at least 2 times the average diameter of the non-lipophilic particles contained therein, preferably it exceeds said average diameter by at least a factor 3. Typically, the agglomerate will have a diameter in the range of 30-200 μm, especially within the range of 40-180 μm, most preferably within the range of 50-160 μm.

The inventors have found that the granulates of the present invention are particularly useful for the controlled delivery of functional ingredients in e.g. dough if they combine the following features:
the granules have an average diameter in the range of 40-290 μm, preferably of 50-250 μm;
the agglomerate of non-lipophilic particles and discrete continuous phase has a mean diameter in the range of 30-200 μm;
the plurality of non-lipophilic particles have an average diameter in the range of 10-150 μm, preferably in the range of 20-100 μm;
the granules contain 50-90 wt. % of the agglomerate of non-lipophilic particles and discrete continuous phase, and 10-50 wt. % of the exterior lipid layer;
the agglomerate contains 10-70 wt. % of the non-lipophilic particles and 30-90 wt. % of the discrete continuous phase.

The above combination of features ensures that on application in a food product, the functional food ingredients can be delivered homogeneously throughout the product matrix, i.e. without the occurrence of so called “hot spots”, even when the granulate is added in relatively small dosages, e.g. below 2% by weight of the food product.

The present invention provides granulates that show little leakage even at high payloads. Consequently, in a preferred embodiment, the plurality of non-lipophilic particles represents between 10 and 45 wt. %, more preferably between 12 and 35 wt. % of the granules. According to a particularly preferred embodiment at least 80 wt. % of the non-lipophilic particles have a diameter in the range of 20-200 μm, more preferably in the range of 25-150 μm and most preferably in the range of 30-120 μm.

In another particularly preferred embodiment, the discrete continuous phase exhibits a slip melting point of at least 30° C., more preferably of 30-45° C., and the slip melting point of the exterior lipid layer does not exceed the slip melting point of the discrete continuous phase by more than 5° C., more preferably the slip melting point of the exterior lipid layer does not exceed the slip melting point of the discrete continuous phase. Advantageously, the exterior lipid layer exhibits a melting point of 30-50° C., more preferably of 32-45° C.

The application of a discrete continuous phase with a slip melting point of 30-45° C. in combination with a exterior lipid layer with a slip melting of at least 30° C., the latter slip melting not exceeding the former one by more than 5° C., ensures that the granulate will effectively deliver the functional food ingredients in a food product when the temperature of said product is raised to well above ambient temperatures. When used in dough, the functional food ingredients will be retained in the granules during mixing and shaping and be released into the dough during proofing. Typically, most if not all of the functional ingredients will have been released into the dough before baking.

The granules according to the present invention offer the important advantage that they can be used to deliver functional ingredients in a controlled fashion. Such a controlled delivery is particularly desirable for functional ingredients such as enzymes, oxidoreductants, micro-organisms, acidulants and flavours. In an even more preferred embodiment the functional ingredients are selected from enzymes, oxidoreductants and combinations thereof. Most preferably, the functional ingredients are enzymes.

The present granulates make it possible to steer the activity of enzymes contained therein in such a way, that enzymatic degradation of starch, pentosans and/or protein in the dough does not occur prematurely. The delayed release of the enzyme following temperature increase as result of mixing or increased proofing temperatures (typically between 30° C. and 40° C. at approximately 75-85% RH) ensures that enzymatic degradation commences not earlier than at the end of the mixing process and during proofing. Thus, enzyme granulates according to the present invention offer the important advantage that they:

(i) enable the use of enzymes that normally cannot be used as they have a very detrimental effect on dough handling during mixing and kneading;

(ii) allow high dosing of enzymes, leading to softer crumb texture, better freshness and higher volume without the usual negative effects on dough handling and dough stability associated with premature degradation of the cereal polymers (starch, pentosan, gluten).

According to one particular embodiment of the invention the non-lipophilic particles contain at least 10 wt. % of one or more food components selected from the group of carbohydrates, proteins, salt and functional food ingredients, said functional food ingredients representing at least 0.1 wt. % of the non-lipophilic particles and being selected from the group of enzymes, oxidoreductants, acidulants, hydrocolloids, micro-organisms, flavours and combinations thereof.

The non-lipophilic particles contained in the present granules preferably contain at least 30 wt. %, more preferably at least 50 wt. % and most preferably at least 80 wt. % of the one or more food components selected from the group of carbohydrates, proteins, salt and functional food ingredients. The carbohydrates and proteins or a fraction thereof may suitably be incorporated in the granules in the form of e.g. flour.

In case the functional food ingredient is an enzyme, it is beneficial to employ a combination of such enzyme and a substantial amount of non-lipophilic carrier in the present non-lipophilic particles. Typically, if the non-lipophilic particles contain one or more enzymes, said enzymes are represent in said particles in a concentration of at least 0.01 wt. %, preferably of at least 0.05 wt. % and more preferably of at least 0.1 wt. %. Usually, the amount of enzyme contained in the non-lipophilic particles does not exceed 20 wt. %. Preferably, said amount does not exceed 5 wt. %, more preferably it does not exceed 3 wt. %.

Functional food ingredients other than enzymes typically represent at least 1 wt. % of the non-lipophilic particles. According to a particularly preferred embodiment, the non-lipophilic particles contain at least 30 wt. %, preferably at least 50 wt. % of hydrocolloid, flour, gluten, salt, sugar or a mixture thereof. Particularly advantageous are granulates in which the non-lipophilic particles contain between 0.1 and 5 wt. % enzyme and at least 20 wt. % hydrocolloid.

As mentioned herein before, the present invention offers the advantage that it enables the preparation of homogeneous and uniform granulates that contain granules in which two or more different particulate materials, especially two or more different types of non-lipophilic particles, have been incorporated. The advantages of this embodiment of the invention are particularly pronounced if the different particulate materials are not only chemically different but also exhibit substantial differences in terms of bulk density and/or mean particle size, e.g. a difference in bulk density of at least 10%, or even at least 20% and/or a difference in mean particle size of at least 20% or even at least 50%.

In a preferred embodiment of the invention the continuous phase that holds together the non-lipophilic particles within the agglomerate constitutes at least 35 wt. %, more preferably at least 40 wt. % of the agglomerate. Typically, said continuous phase will not represent more than 80 wt. % of the agglomerate, more preferably it does represents no more than 75 wt. % of the agglomerate. Most preferably, the agglomerate contains 25-60 wt. % of the plurality of non-lipophilic particles and 75-40 wt. % of the discrete continuous phase. The continuous phase that holds together the non-lipophilic particles may suitably contain at least 60 wt. %, preferably at least 80 wt. % and most preferably at least 90 wt. % lipids. The lipids present in the discrete continuous phase are suitably selected from the group consisting of triglycerides, diglycerides, monoglycerides, phospholipids, datems, lactems, citrems, acetems, stearyl-lactylates, polyglycerol esters, sucrose esters of fatty acids, fatty acids, waxes, soaps and combinations thereof. More preferably, the lipids are selected from the group consisting of triglycerides, diglycerides, monoglycerides, datems. Most preferably, the lipids employed are triglycerides. Waxes typically have melting points well in excess of 60° C. When wax is employed in large amounts in the present granulate, release characteristics are adversely affected in that enzyme activity will be released predominantly during baking, instead of during proofing. Hence, according to a preferred embodiment, the discrete continuous phase contains less than 20 wt. % wax. More preferably, said continuous phase contains less than 10 wt. % wax, most preferably it contains no wax. For these same reasons it is preferred that also the exterior lipophilic layer contains wax in the aforementioned reduced amounts.

The use of a continuous phase based on lipids offers the advantage that it is relatively easy to enrobe the agglomerate with an exterior lipophilic layer. Furthermore, the use of lipophilic continuous phase enables the preparation of granules with unique sustained release characteristics, especially if said continuous phase exhibits a slip melting point of at least 25° C., more preferably of at least 30° C.

The exterior lipophilic layer suitably contains at least 60 wt. %, more preferably at least 80 wt. %, and most preferably at least 90 wt. % lipids selected from the group consisting of triglycerides, diglycerides, monoglycerides, phospholipids, datems, lactems, citrems, acetems, stearyl-lactylates, polyglycerol esters, sucrose esters, fatty acids, waxes, soaps and combinations thereof. In a particularly preferred embodiment the aforementioned lipids are selected from the group consisting of triglycerides, diglycerides, monoglycerides and datems, triglycerides being most preferred.

The present invention offers the advantage that high payloads of non-lipophilic particles can be realised without serious leakage without using large amounts of encapsulating material, notably the discrete continuous phase and the exterior lipid layer. As described above, the discrete continuous phase typically represents no more than 80 wt or even no more than 75 wt. % of the agglomerate core. Due to the fact that the non-lipophilic particles have been partly encapsulated by the discrete continuous phase, it is feasible to achieve effective encapsulation even when applying a relatively thin exterior lipid layer. Thus, advantageously the granules in the present granulate contain 12-40 wt. %, most preferably 15-30 wt. % of the exterior lipid layer. Typically, the exterior lipid layer has a thickness in the range of 6-25 μm, preferably of 7-20 μm.

The present invention encompasses granules in which the composition of the discrete continuous phase and the exterior lipophilic layer are identical. According to a preferred embodiment the composition of the continuous phase and the exterior layer is different as evidenced, for instance, by a different slip melting point.

The inventors have found that granules comprising an exterior layer containing at least 50 wt. % triglyceride fat with a slip melting point of at least 30° C. and at least 1 wt. % of a release agent selected from the group of monoglycerides, diglycerides, diacetyl tartaric acid ester of mono- and/or diglyceride (datem), stearyl-lactylates, and combinations thereof, perform particularly well, especially in bakery applications. Although the inventors do not wish to be bound by theory, it is believed that the aforementioned release agents enable the controlled release of the functional bakery ingredient(s) after the granules have been incorporated in e.g. dough and in particular that they enable a release that increases rapidly with increasing temperature. As compared to the coated and encapsulated systems known from the prior art, granules provided with a coating that contains a combination of triglycerides fat and release agent offer the advantage that the functionality is generally released in a more gradual way, allowing the functional ingredient to already exert some of its functionality early on during e.g. a dough preparation process. In case of enzymes, for instance, such an early controlled action is desired to produce a baked product with good consistency and volume.

The granules according to the present invention advantageously contain: 10-60 wt. %, preferably 15-50 wt. % of the plurality of non-lipophilic particles; 15-40 wt. %, preferably 20-40 wt. % of the discrete continuous phase; and 15-60 wt. %, preferably 15-45 wt. % of the exterior lipophilic layer. Typically, these three components together constitute at least 80 wt. % of the granule, more preferably at least 90 wt. % of the granule and most preferably 100 wt. % of the granule.

The discrete continuous phase and/or exterior lipophilic layer of the present granulate may suitably contain a substantial amount of lipids in the form of emulsifier. The present granulate is perfectly suited for delivering emulsifiers into food products. Furthermore, as described above, the incorporation of emulsifiers in the present granulate offers the advantage that it can improve the release characteristics of the granulate. Thus, in an advantageous embodiment of the invention the granulate contains at least 20 wt. %, more preferably at least 30 wt. % and most preferably at least 40 wt. % of emulsifier that is contained in the discrete continuous phase and/or exterior lipophilic layer. Said emulsifier is suitably selected from the group consisting of diglycerides, monoglycerides, phospholipids, datems, lactems, citrems, acetems, stearyl-lactylates, polyglycerol esters, sucrose fatty acid esters and combinations thereof. Most preferably, the emulsifier is selected from the group consisting of diglycerides, monoglycerides, datems, stearyl-lactylates and combinations thereof.

The present composition may suitably contain other, preferably particulate, ingredients in addition to the present granules. One embodiment of the present composition is a bread improver composition, especially a bread improver composition that additionally contains at least one or more bread improving ingredients selected from the group consisting of emulsifiers, oxidoreductants, acidulants, salt, sugars, flour, yeast, protein, dairy ingredients, and fat. Typically, the present granules and the aforementioned bread improving ingredients together constitute at least 20%, preferably at least 60% and most preferably at least 90% of the present composition, by weight of dry matter. The bread improver composition according to the invention may be a liquid bread improver formulation in which the granules and other bread improving ingredients are dispersed into a liquid, e.g. water or liquid triglyceride oil. Alternatively, and most preferably, the bread improver composition is a particulate, free flowing powder. Typically, such a free flowing powder contains at least 80 wt. %, preferably at least 90 wt. % of particles with a particle size within the range of 200-1000 μm.

Another embodiment of the invention relates to a composition that contains at least 80 wt. %, more preferably at least 90 wt. % and most preferably at least 100 wt. % of the present granules. Such a composition may be applied as such directly in food products or it can suitably be pre-blended with other food ingredients, e.g. into a bread improver composition.

The desirable feature that the present granules show little or no leakage is achieved by the presence of an intact exterior lipophilic layer that seals off the non-lipophilic particles from the environment. Indeed, when viewed under a microscope, the granules within the present composition contain not more than a small fraction of granules in which the exterior lipophilic layer is penetrated by one or more non-lipophilic particles. Typically, less than 30 wt. % of the granules exhibit such a defect. More preferably, less than 15 wt. %, and most preferably less than 5 wt. % of the granules exhibit this particular defect.

The present invention offers the advantage that it enables the incorporation of irregularly shaped non-lipophilic particles into granules whilst ensuring that these particles are entirely encased in an exterior lipophilic layer. In order to achieve this, it is advantageous to combine the irregularly shaped non-lipophilic particles into an agglomerate with a much less irregular shape. This requirement may be expressed mathematically as follows:
Δₙₚ≧0.4 and
Δ_{ag}/Δₙₚ≦0.6
wherein:
Δ=E[(d₁−dₛ)/(d₁+dₛ)]
Δₙₚ represents Δ of the non-lipophilic particles;
Δ_{ag} represents Δ of the agglomerates;
d₁ represents the largest diameter of a particle or agglomerate;
dₛ represents the smallest diameter of the same particle or agglomerate;
and E(x) represents the expected value for x.

In a particularly preferred embodiment, Δₙₚ is at least 0.5, most preferably at least 0.6. The ratio Δ_{ag}/Δₙₚ preferably does not exceed 0.5, most preferably it does not exceed 0.4.

Another aspect of the invention relates to the use of a composition as defined herein in the preparation of dough or a batter, preferably bread dough. The dough or batter may simply be prepared by mixing the present composition with the other dough or batter components, e.g. flour, water and/or yeast. Usually the present composition is incorporated in an amount sufficient to deliver between 0.01 and 5% of the present granules by weight of the dough or batter. Consequently, the present invention also provides a dough or batter comprising between 0.01 and 5 wt. % of the granules as defined herein before.

Yet another aspect of the invention relates to a method of manufacturing a granulate composition as defined above, especially a composition comprising granules with an average diameter in the range of 30-290 μm, said method comprising:

a. providing non-lipophilic particles with an average diameter in the range of 10-150 μm, preferably in the range of 20-100 μm, said particles containing at least 0.1 wt. % of one or more functional food ingredients;

b. combining said non-lipophilic particles with a first molten lipid material with a melting of 30-45° C. in a weight ratio of 1:9 to 7:3, followed by mixing so as to obtain a homogeneous dispersion of the non-lipophilic particles in the molten lipid material,

c. converting the homogenous dispersion into agglomerates in which a plurality of the non-lipophilic particles is enveloped by a discrete continuous lipid phase, said agglomerates exhibiting an average diameter in the range of 30-200 μm;

d. coating said agglomerates with a second molten lipid material with a melting point of at least 30° C. so as to produce coated agglomerates that are fully encompassed by an exterior lipid layer, wherein the melting point of said exterior lipophilic layer does not exceed the melting point of the discrete continuous lipid phase by more than 5° C.;

e. cooling the coated agglomerates to ambient temperature or lower; and

f. collecting the coated agglomerates to obtain the granulate.

It was found that the homogeneous dispersion can be converted into agglomerates using relatively small amounts of lipid material if the homogeneous dispersion is converted into agglomerates by means of spray chilling or extrusion, spray chilling being most preferred.

It is noted that the present invention also encompasses a method wherein subsequent to agglomeration and prior to the coating step d. the agglomerate is subjected to a size reduction treatment (e.g. milling), a fractionation step (e.g. sieving or wind sifting), a rounding off treatment or an intermediate coating step. The coating step c. of the present method can suitably be executed using coating techniques well known in the art. Preferably, the coating technique employed is selected from fluidised bed coating or rotating drum coating. Most preferably, the exterior lipophilic layer is applied by means of fluidised bed coating. Fluidised bed coating offers the advantage that the agglomerates are not exposed to substantial abrasive forces. Thus, coated particles with a very uniform particle size and intact exterior coatings can be prepared relatively easily.

The invention is further illustrated by means of the following examples:

### EXAMPLES

### Example 1

Spray Chilling

A steep melting fat (Akofine™ W00; N₂₅=89%; N₃₀=48%; N₃₅=3%) with a melting point of 35° C. was molten in a container. Fungamyl™ 1600 BG (ex Novozymes), a bakery enzyme (amylase) granulate with a mean particle size of 160 μm, was milled to a mass weighted mean diameter of 87 μm and subsequently dispersed into the molten fat with the help of a high shear mixer (Polytron PT3100). The resulting fat dispersion contained 10 wt. % enzyme granulate.

Atomisation of the molten fat dispersion was performed with a heated two-fluid spray nozzle. The nozzle was kept at a preset temperature well above the melting point of the fat. The fat dispersion was fed via a peristaltic pump through heated tubes towards the nozzle and atomised by nitrogen gas under pressure. The particle size of the atomized fat was adjusted to around 500 μm by adapting the atomisation pressure. The droplets were sprayed into a liquid nitrogen bath and collected at the end of the process. The granulate so obtained had a mass weighted average diameter of about 500 μm.

The fat coated particulate material so obtained was divided into two samples, i.e. granulate A and granulate B.

Fluidised Bed Coating

A GPCG-1.1 fluidised bed coater of the firm Glatt with Wurster geometry and hot-melt facilities was used for applying an external coating to the spray chilled particles contained in sample A as well as to the milled Fungamyl™ 1600 BG enzyme preparation. The hot-melt Wurster method employs a high-velocity air stream through a cylinder that is centrally placed just above the air inlet at the narrow bottom of a conus shaped chamber. The air speed inside the cylinder is significantly higher than outside. Thus, during operation, the fluid bed of particles is continuously circulating upwards through the cylinder and downwards outside the cylinder.

Granulate A was introduced into the conus shaped chamber of the coating apparatus and a fluidised bed was formed. The coating material, i.e. the same fat as used in the spray chilling step, was molten and fed through heated tubes towards the nozzle. The fat coating was applied onto the granulate A by spraying the molten fat from the nozzle onto the fluidised granules within the cylinder. During the coating process particles left the top of the cylinder and descended back into the fluidized bed. Cool air congealed the coating during the descent so that the particles were ready to be recoated once they reached the bottom of the chamber. The granulate A so obtained had a mass weighted average particle size of about 600 μm. Of the fat contained in the granulate A, 50% was present within the spray chilled core particle and 50% in the fat layer that was applied during fat coating.

The milled enzyme granulate was coated in the same fashion. The resulting coated granulate C had a mass weighted average particle size of 285 μm. The fat layer applied during the coating process represented 59% wt. % of the granulate C.

Microscopy

Granulates A and B were studied under a light microscope using the bright field mode. Since the fat contained in the granules is more translucent than the Fungamyl™ particles it was readily apparent from the microscopic images that a plurality of the enzyme particles had been entrapped within the granulates A and B.

A significant fraction of the enzyme particles in granulate B were embedded in the exterior surface of the granules, i.e. in direct contact with the surrounding atmosphere. In contrast, the microscopic images of granulate A showed that the granules contained an intact coating layer of about 20-50 μm thickness which enveloped the enzyme containing core granule.

drawings

FIGS. 1 and 2 provide a schematic cross-sectional representation of granules that are typical of granulate A and B. These drawings were prepared on the basis of the microscopic images discussed above.

FIG. 1 shows granule 1 as obtained after spray chilling a dispersion of enzyme material in fat. The granule 1 contains a plurality of particles 3 consisting of enzyme material. These particles 3 are enrobed and held together by a continuous fat phase 2. A significant number of the particles 3 in granule 1 are only partially embedded in the continuous fat phase 2 and in direct contact with the outside atmosphere. FIG. 1 also shows that granule 1 is much more regularly e.g. spheroidally shaped than the plurality of particles 3 entrapped therein.

FIG. 2 shows granule 5 as obtained after fluidised bed coating of granule 1. Granule 5 contains an exterior fat coating 4 that fully envelops the granule 1 obtained from the aforementioned spray chilling step. As is evident from FIG. 2, the fat coating 4 seals of all the particles 3 from the surrounding atmosphere. Thus, when in direct contact with water, granule 5 will exhibit much less leakage than granule 1.

Stability Test

The stability of granulates A, B and C was assessed by dispersing a small quantity of the granulates in deionised water of 20° C. The conductivity of the water was monitored a function of time. The conductivities measured were expressed as a percentage of the maximum conductivity measured when the granulate had been totally destroyed by heating to 60° C.

The results showed that within 20 minutes conductivity for granulate C had increased to 80% of maximum conductivity. The conductivity increase observed for granulate B was less steep, but after 100 minutes conductivity had increased to 24% of the maximum value. In contrast, no significant increase in conductivity was observed for granulate A after 100 minutes. Even after 20 hours the conductivity for granulate A had increased to not more than 10% of the maximum conductivity.

### Example 2

Granulates A and B were produced in the same way as described in Example 1, except that granulate A was obtained by coating granulate B with a much smaller amount of fat. Of the fat contained in granulate A 85% was present within the spray chilled core particle and 15% in the fat layer that was applied during fat coating. Again, the conductivity test showed that granulate A was much more stable than granulate B.

### Example 3

The following ingredients were dry-mixed in the weight ratios indicated:

High amylose starch (National 1900, ex National Starch): maltodextrin

(Granadex™ MD20, ex Avebe): micro crystaline cellulose (Vivapur™ MCC, type 101, ex Rettenmaier & Sohne): Fungamyl™ 1600 BG in a weight ratio of 22.5:22.5:45:10.

Water was added (40 wt. % of wet mix) and the wet mix was kneaded till a dough with a short structure had been formed. This dough was extruded under low pressure from a Nica™ basket extruder. The spaghetti-like extrudate was dropped onto a rotating disk at the bottom of a spheronisation drum. Here, the extrudate was fractured and spheronised. Small amounts of micro crystalline cellulose were added in this process to reduce stickiness of the particles. The spheronised granulate was subsequently dried in a fluid bed drier (Glatt GPCG 1.1). The granulate so obtained had a mass weighted mean diameter of 1.5 mm.

Subsequently, the dried granulate was coated in a fluidised bed coater as described in Example 1. The resulting coated granulate had a mass weighted mean diameter of 1.6 mm. Conductivity tests were performed as described in Example 1 and showed that the coated particles exhibited little leakage.

### Example 4

An enzyme containing granulate was prepared by first milling a commercial α-amylase preparation (BAN800 ex NOVO). The particle size distribution of the original enzyme preparation (before milling) was:

54.35%>250 μm; 0.9%<100 μm; 0%<50 μm.

After milling the particle size distribution was:

99.8%<250 μm; 74%<100 μm; 30%<50 μm; 11%<20 μm.

Next, the milled enzyme preparation was encapsulated in a two step process employing spray crystallisation followed by fluidised bed coating. Before spray crystallisation the enzyme particles were homogeneously dispersed into molten fat (hydrogenated palm oil with a melting point of 45° C.) in a weight ratio of enzyme particles to fat of 1:9, using an Ultra Turrax™ mixer. The temperature of the fat and the homogenised suspension was kept at ca. 10-15° C. above the fat melting point in order to prevent premature crystallization. The homogenised suspension was crystallised at a rate of 310 g/min in a Glatt CPCG 15 spray chilling device, using a nozzle diameter of 22 mm, a spray pressure of 3.5 bar and valve position 19. The micronised suspension was cooled by means of cold air (500 m³/hr). The inlet temperature of the cold air was 8° C. and the exit temperature 12° C. After 6 minutes of spraying the crystallised powder was removed.

Subsequently, the spray crystallised particles were transferred into a Glatt CPCG 1 fluidised bed coater. A coating liquid consisting of hydrogenated palm oil (melting point of 45° C.) was sprayed onto the fluidised enzyme particles at a rate of 17 g/min, using a nozzle diameter of 22 mm a spray pressure of 2.5 bar. Air (19° C.) was introduced at a rate of 57 m³/hr to maintain a fluid bed, using valve position 28. The amount of coating material applied in the fluid bed coater represented approximately 10% by weight of the spray crystallised particles. The particle size of the granulate obtained from the fluidised bed coater was largely within the range of 30-200 μm.

Both the granulate obtained from the fluid bed coater and the spray crystallised powder were applied in accordance with the following dough recipe:

| | A | B |
|---|---|---|
| Flour [g] | 3000 | 3000 |
| Water [g] | 1800 | 1800 |
| Yeast [g] | 120 | 120 |
| Salt [g] | 60 | 60 |
| Ascorbic Acid [mg] | 300 | 300 |
| Hydrogenated Palm Fat mp 45° C. [mg] | — | 60 |
| Spray crystallised enzyme powder [mg] | — | 600 |
| Fluid bed coated granulate [mg] | 660 | — |

It was found that dough A was much easier to handle than dough B as it was less sticky.

Next, the dough was shaped and baked to produce loafs of 600 g. The crumb structure of loafs A was more regular that the crumb structure of loafs B. Furthermore, the crumb of loaf B was totally non-elastic and very sticky, whereas the crumb of loaf A was quite elastic and only slightly sticky, showing that type A granulates can be used to deliver high dosages of α-amylase without introducing negative dough properties and damaged crumb structure.

### Example 5

Example 4 was repeated except that the amylase preparation was not milled prior to spray crystallisation. The resulting fluid bed coated granulate was applied in dough according to the recipe described in example 4. The dough handling properties were found to be inferior compared to dough A and similar to dough B in example 4. It was found that hot spots occurred in the crumb, resulting in localised destruction of the crumb structure.

1-21. (canceled)

22. A composition comprising at least 0.1 wt. % of granules suitable for use in foodstuffs, said granules having an average diameter in the range of 30-3000 μm and comprising:
a. 3-70 wt. % of a plurality of non-lipophilic particles with an average diameter in the range of 3-300 μm, said particles containing at least 10 wt. % of one or more food components selected from the group of carbohydrates, proteins, salt and functional food ingredients and at least 0.1 wt. % of one or more functional food ingredients, said functional food ingredients being selected from the group of enzymes, oxidoreductants, acidulants, hydrocolloids, micro-organisms, flavours and combinations thereof;
b. 10-80 wt. % of a discrete continuous phase containing at least 90 wt. % lipids, which continuous phase envelops the non-lipophilic particles and holds them together, the combination of non-lipophilic particles and the continuous phase forming an agglomerate with a mean diameter in the range of 30-200 μm; and
c. 10-80 wt. % of an exterior lipophilic layer that encompasses the agglomerate, which lipophilic layer exhibits a slip melting point of at least 30° C.

23. The composition according to claim 2, wherein the average diameter of the granules is in the range of 40-290 μm, said granules comprising:
50-90 wt. % of the agglomerate, said agglomerate having a mean diameter in the range of 30-200 μm and containing:
i. 10-70 wt. % of a plurality of the non-lipophilic particles, said non-lipophilic particles having an average diameter in the range of 10-150 μm; and
ii. 30-90 wt. % of the discrete continuous phase, said discrete continuous phase exhibiting a slip melting point of at least 30° C.; and
10-50 wt. % of the exterior lipid layer, wherein the slip melting point of said exterior lipid layer does not exceed the slip melting point of the discrete continuous phase by more than 5° C.

24. The composition according to claim 22, wherein the plurality of non-lipophilic particles represent between 10 and 40 wt. %.

25. The composition according to claim 22, wherein the non-lipophilic particles contain between 0.01 and 5 wt. % of enzyme.

26. The composition according to claim 22, wherein the non-lipophilic particles contain at least 30 wt. % of hydrocolloid, flour, gluten, salt, sugar or a mixture thereof.

27. The composition according to claim 22, wherein the agglomerate contains 25-60 wt. % of the plurality of non-lipophilic particles and 75-40 wt. % of the discrete continuous phase.

28. The composition according to claim 22, wherein the granules contain 15-30 wt. % of the exterior lipid layer.

29. The composition according to claim 22, wherein the exterior lipid layer has a thickness in the range of 6-25 μm.

30. The composition according to claim 22, wherein the exterior lipid layer exhibits a melting point of 30-50° C.

31. The composition according to claim 22, wherein the lipids in the discrete continuous phase are selected from the group consisting of triglycerides, diglycerides, monoglycerides, phospholipids, datems, lactems, citrems, acetems, stearyl-lactylates, polyglycerol esters, sucrose esters of fatty acids, fatty acids, waxes, soaps and combinations thereof.

32. The composition according to claim 22, wherein the functional food ingredient is selected from the group consisting of enzymes, oxidoreductants, acidulants, micro-organisms, flavours and combinations thereof.

33. The composition according to claim 22, wherein the exterior lipophilic layer contains at least 80 wt. % lipids selected from the group consisting of triglycerides, diglycerides, monoglycerides, phospholipids, datems, lactems, citrems, acetems, stearyl-lactylates, polyglycerol esters, sucrose esters, fatty acids, waxes, soaps and combinations thereof.

34. The composition according to claim 22, said granules containing:
10-60 wt. % of the plurality of non-lipophilic particles;
15-40 wt. % of the discrete continuous phase; and
15-60 wt. % of the exterior lipophilic layer.

35. The composition according to claim 22, wherein the melting point of the exterior layer does not exceed the melting point of the discrete continuous phase.

36. The composition according to claim 22, wherein the composition contains at least 10 wt. % of the granules.

37. A method of preparing a dough or a batter, said method comprising adding a granules containing composition, said composition comprising at least 0.1 wt. % of granules suitable for use in foodstuffs, said granules having an average diameter in the range of 30-3000 μm and comprising:
a. 3-70 wt. % of a plurality of non-lipophilic particles with an average diameter in the range of 3-300 μm, said particles containing at least 0.1 wt. % of one or more functional food ingredients
b. 10-80 wt. % of a discrete continuous phase containing at least 90 wt. % lipids, which continuous phase envelops the non-lipophilic particles and holds them together, the combination of non-lipophilic particles and the continuous phase forming an agglomerate with a diameter in the range of 20-2000 μm; and
c. 10-80 wt. % of an exterior lipophilic layer that encompasses the agglomerate, which lipophilic layer exhibits a slip melting point of at least 30° C.

38. A dough or a batter comprising between 0.01 and 5 wt. % of the granules as defined in claim 37.

39. A method of manufacturing a composition according to claim 23, said method comprising:
a. providing non-lipophilic particles with an average diameter in the range of 10-150 μm, said particles containing at least 10 wt. % of one or more food components selected from the group of carbohydrates, proteins, salt and functional food ingredients and at least 0.1 wt. % of one or more functional food ingredients, said functional food ingredients being selected from the group of enzymes, oxidoreductants, acidulants, hydrocolloids, micro-organisms, flavours and combinations thereof;
b. combining said non-lipophilic particles with a first molten lipid material with a melting of 30-45° C. in a weight ratio of 1:9 to 7:3, followed by mixing so as to obtain a homogeneous dispersion of the non-lipophilic particles in the molten lipid material,
c. converting the homogenous dispersion into agglomerates in which a plurality of the non-lipophilic particles is enveloped by a discrete continuous lipid phase, said agglomerates exhibiting an average diameter in the range of 30-200 μm;
d. coating said agglomerates with a second molten lipid material with a melting point of at least 30° C. so as to produce coated agglomerates that are fully encompassed by an exterior lipid layer, wherein the melting point of said exterior lipophilic layer does not exceed the melting point of the discrete continuous lipid phase by more than 5° C.;
e. cooling the coated agglomerates to ambient temperature or lower; and
f. collecting the coated agglomerates to obtain the granulate.

40. The method according to claim 39, wherein the homogeneous dispersion is converted into agglomerates by means of spray chilling or extrusion.

41. The method according to claim 39, wherein the coating step d. employs fluidised bed coating or rotating drum coating.
